(19) United States
(12) Patent Application Publication
(10) Pub. No.: US 2017/0272426 A1
(43) Pub. Date: Sep. 21, 2017

(54) SECURE DOCUMENT STORAGE AND RETRIEVAL

(71) Applicant: SecureDock, LLC, Irvine, CA (US)

(72) Inventor: Donna Wertz, Irvine, CA (US)

(21) Appl. No.: 15/484,650

(22) Filed: Apr. 11, 2017

Related U.S. Application Data
(63) Continuation of application No. 14/217,126, filed on Mar. 17, 2014, now abandoned.
(60) Provisional application No. 61/798,243, filed on Mar. 15, 2013.

(51) Int. Cl. H04L 29/06; G06F 21/62; G06F 11/14; G06F 21/60

(52) U.S. Cl. CPC H04L 63/083; G06F 21/606; G06F 21/6218; G06F 11/1448; H04L 67/306

(57) ABSTRACT

Disclosed herein is a computer-implemented system and method for hosting companies to offer a service of securely retrieving, storing and distributing critical documents for their clients. This can be done for the client by a hosting company administrator on a company administrative site, or by the hosting company's client, the end user, through a private labeled interface provided by a hosting company, via a hosting company's private label entry page. Additionally, the hosting company can administer many functions of the client's accounts through a series of Batch Interfaces thereby working on multiple accounts and functionalities done via one batch function. Also disclosed is a computer-implemented method of permanently storing critical documents in an online retrieval, storage and distribution system created to act as an interface that has predesigned storage boxes, categories and subcategories allowing the client/hosting company to immediately use the system.

This application is a continuation of U.S. application Ser. No. 14/217,126 filed on Mar. 17, 2014, which claims the benefit under 35 U.S.C. §119(e) as a nonprovisional application of U.S. Prov. App. No. 61/798,243 filed on Mar. 15, 2013, each of which are hereby incorporated by reference in their entirety.

### BACKGROUND

Field of the Invention

The present invention relates in some aspects to a system and method for hosting companies to offer a service of securely retrieving, storing and distributing critical documents for their clients. This can be done for the client by a hosting company administrator on a company administrative site, or by the hosting company's client, the end user, through a private labeled interface provided by a hosting company, via a hosting company's private label entry page. Additionally, the hosting company can administer many functions of the client's accounts through a series of Batch Interfaces thereby working on multiple accounts and functionalities done via one batch function. This invention pertains in some respects to a method of permanently storing critical documents in an online retrieval, storage and distribution system created to act as an interface that has predesigned storage boxes, categories and subcategories allowing the client/hosting company to immediately use the system, not having to create a structure for storage. Additionally, customization of these predesigned attributes is possible by the hosting company and/or client.

Description of the Related Art

Trusted advisors have long had to store copies of their client's documents for the purposed of completing their work, thereby then becoming, to their clients, the source of these documents when their clients need them, resulting in many additional man-hours which are difficult to financially account for in a revenue stream. This invention, in some aspects allows the trusted advisor, hosting company, to store those documents in a permanent location where their clients can retrieve them, add additional documents themselves, and distribute documents securely to third parties. This invention, in some aspects, offers permanent storage for the client, the end user, and the account is under the control of the end user, which is different from a company offering a portal system to temporarily give their clients access to one or more documents.

Furthermore, this invention, in some embodiments, offers to the hosting company the benefits of company branding through the private labeling of the client access site and Inbound access site, as well as the internal pages of those sites. Additional benefits are cost savings from the Batch functions, and a company revenue source should the hosting company choose to ask for payment to use the system.

Methods for third parties to store documents onto the Internet are known. For example, U.S. Pat. No. 6,351,776 to O'Brien et al. (the “O'Brien patent”) describes a file storage and retrieval system available worldwide via the Internet, acting in the manner of an Internet “hard disk” or Internet “hard drive.” However, the O'Brien patent requires the end user to install proprietary software onto their computer hardware in order to use this service. This can be burdensome for an end user, or require technical expertise which some end users might lack. For example, an end user who frequently travels may not always have the option of installing software onto a computer.

U.S. Pat. No. 7,136,903 to Phillips et al. (the “Phillips patent”) also describes an online file storage service and system; however, said system is specifically designed to enable numerous users to access a group of files simultaneously. The Phillips patent thus does not describe a method suitable for a single user seeking a secured account which only the end user can access.

U.S. Pat. Pub. No. 2002/0111946 A1 to Fallon et al. describes a method of storing and retrieving documents for end users via the Internet, however the Fallon patent does not provide a method for a hosting company to provide this service for their clients via a private labeled website page, and administer those clients from the hosting companies' administrators. Secure document distribution and secure document delivery directly into an account Inbox is not addressed. Additionally not addressed, among other things, are the use of Batch functions available to the hosting companies.

U.S. Pat. Pub. No. 2008/0244039 A1 to Wertz discloses methods of virtual online storage of documents with a user-friendly interface, and is hereby incorporated by reference in its entirety.

Accordingly, a need arises for hosting companies to have use of a service to offer their clients which securely and permanently stores their clients documents, their clients have access to the documents and all the other benefits of the system, and control the account while using the system.

### SUMMARY

Disclosed herein is a computer-implemented system for secure cloud-based document management. The system can include a primary data store that stores a current version of an electronic file of a user within a secure account of the user; a backup data store that stores the current or a previous version of the electronic file of a user as of a specific backup date; a deletion module configured to receive a request from a user to securely delete the electronic file from at least the primary data store; a search module configured to attempt to locate the electronic file of the user on the data store and the backup data stores, and send a confirmation that the electronic file of the user is no longer found on either the data store or the backup data stores; and a communications engine configured to receive the confirmation from the search module that the electronic file of the user is not found, and upon receipt of the confirmation electronically communicate to the user a certification of deletion of the electronic file, wherein the certification of deletion indicates that the data store and at least one backup data store no longer contain the electronic file, and the electronic file has been permanently and securely deleted. In some embodiments, the backup data store is a mirrored data store. The backup data store can store a version of the electronic file of the user as of the specific backup date. The deletion module can be configured to delete the primary data store and the backup data store at the same time. The search module can be configured to attempt recovery of the electronic file on at least one of the primary data store and the backup data store.

Also disclosed herein is a computer-implemented system for secure cloud-based document management. The system can include a primary data store that stores a current version of an electronic file of a first user within a secure account of the first user; a login module configured to require from the first user for an initial login a username associated with the secure account, a password associated with the secure account, and a CAPTCHA challenge-response, the login module having an activatable functionality configured to require from the first user on a subsequent login within a pre-determined time period after the initial login only the password associated with the secure account but not the username associated with the secure account nor the CAPTCHA; wherein the login module can effect the subsequent login irrespective of the first user's Internet browser settings, wherein the predetermined time period is about 24 hours. The system can also include an upload module configured to electronically send a unique upload hyperlink to a third party uploader, the upload hyperlink associated with the secure account of the first user and configured to allow the third party uploader to upload at least one third party file within the secure account of the first user upon navigating to the upload hyperlink without requiring the username of the secure account or the password of the secure account, wherein the upload module does not allow the third party uploader to see the contents of the secure account of the first user. The upload module can be configured to expire the upload hyperlink after one-time use, after a pre-determined plurality of uses, or after a pre-determined period of time, or immediately upon receiving an electronic request from the first user. In some embodiments, also disclosed is a download module configured to electronically send a unique download hyperlink to a third party downloader, the download hyperlink associated with the secure account of the first user and configured to allow the third party uploader to download at least one third party file from the secure account of the first user upon navigating to the download hyperlink without requiring the username of the secure account or the password of the secure account, wherein the download module does not allow the third party downloader to see the contents of the secure account of the first user other than the at least one third party file. The system can also include an administrator module, the administrator module configured for batch processing configured to do one or more of the following functions: (1) create a plurality of secure accounts simultaneously, the plurality of secure accounts associated with a plurality of users, the plurality of secure accounts configured to hold electronic batch documents; (2) electronically send login credentials corresponding to the plurality of client accounts to new clients simultaneously; (3) set a plurality of client accounts to an active state or an inactive state simultaneously; and (4) upload or download the electronic batch documents to the plurality of existing client accounts simultaneously.

Also disclosed herein is a computer-implemented system for secure cloud-based document management, that includes a primary data store that stores a plurality of electronic files of a user within a secure account of the user, the electronic files configured to be contained within a plurality of electronic boxes separating the electronic files by definable categories, wherein the plurality of electronic boxes comprises an electronic medical information box comprising at least one medical information file and at least one electronic non-medical information box, the electronic medical information box having a security access setting different from the security access setting of the non-electronic medical information box of the user, wherein the secure account is configured to be accessed by a user by entering a login and password associated with the user's secure account, and wherein the electronic medical information box of the user can be accessed by a third party via a third party access module without requiring access to the login and password associated with the user's secure account, the third party access module allowing access from an access mechanism selected from the group consisting of: a QR code linking directly to the user's electronic medical information file within the electronic medical information box, and a hyperlink to the user's electronic medical information box, wherein the third party does not have access to the non-electronic medical information box of the user's secure account. The electronic medical information can be selected from the group consisting of the client's name, emergency contact name and contact information, insurance information, primary care and/or specialty care physician information, advance directives, health care power of attorney information, past medical history, past surgical history, medication list, allergies, family history, social history, blood type, do not resuscitate documents, and laboratory information. The third party access module can include a feature configured to allow the third party to dial emergency medical services immediately upon allowing access from the access mechanism.

In some embodiments, systems and methods are disclosed for hosting companies to offer a service of securely retrieving, storing and distributing critical documents for their clients. This can be done for the client by a hosting company administrator on a company administrative site, or by the hosting company's client, the end user, through a private labeled interface provided by a hosting company, via a hosting company's private label entry page. Additionally, the hosting company can administer many functions of the client's accounts through a series of Batch Interfaces thereby working on multiple accounts and functionalities done via one batch function. In some embodiments, this invention pertains to a method of permanently storing critical documents in an online retrieval, storage and distribution system created to act as an interface that has predesigned storage boxes, categories and subcategories allowing the client/hosting company to immediately use the system, not having to create a structure for storage. Additionally, customization of these predesigned attributes is possible by the hosting company and/or client.

In some embodiments, computer-implemented systems and methods can include one, two or more of the following features or combinations or subcombinations thereof: In some embodiments, the document management system includes batch system functionality. Hosting company administrators can utilize batch functions, that is, executing a series of computer-implemented tasks without necessarily requiring manual intervention. In some embodiments, the deposit quadrant 102 allows for the creation of multiple accounts. Administrators can upload data to create multiple client profiles, thereby setting up multiple accounts at one time. These accounts can be set up, for example, to bill internally, through the system via credit card, or externally, whereby the system will not bill the client. In some embodiments, using the deposit quadrant 102 administrators can set multiple client accounts as active or inactive with a single command function. In some embodiments, using the deposit quadrant 102 administrators can send out initial or subsequent login credentials to multiple clients on the system with one function. Furthermore, in some embodiments, administrators can upload or download a particular document or multiple selected documents to multiple clients on the system with one function.

The deliver quadrant 104 for example, can allow for an administrator to communicate via email with all clients, or a sub-set of clients that they choose (e.g., by selecting for certain client demographic information) with a single function. Hosting companies can also have a document sent to them via an electronic link, wherein the document is directly stored into their secure account inbox or their standard email inbox. The sending party can access a link on the hosting company's website, or any other place they choose to place the link, e.g., in their email signature, which takes them to a website listing the company recipients. They select a recipient, upload the document and the document is delivered into the recipients secure account inbox or to their standard email inbox. In some embodiments, this can be advantageous as no account setup or password is required by the sender. Each document is delivered with an electronic manifest showing information that can include, for example, the senders' name, date and time the document was sent and/or opened, and the title of the document. A record of all documents received can be kept and accessible by the account holder on the system. The hosting company can have multiple recipient lists to accommodate multiple office locations.

Further in the deposit quadrant 102, hosting companies have the option to turn on or off the function of viewing their clients' documents on the administrative site. This is configurable in, for example, one or more of the following ways: (a) Viewable or not for all clients served by the hosting company; (b) viewable or not for an individual client; or (c) viewable or not for a particular secure box within a client's account.

In some embodiments, in the deposit quadrant 102, applications can be made from customized APIs for hosting companies such that document management systems that are disclosed herein can integrate with the hosting company's document management system, thereby allowing hosting companies to upload documents in a more rapid fashion directly into the document management system.

In some embodiments, different visuals, such as color schemes or other alerts can distinguish administrator and client files. For example, on the hosting company's administrative site boxes and documents added by the hosting company's administrator are shown in blue, and boxes and documents added by clients are shown in green.

In some embodiments, such as using the deploy quadrant 106, hosting companies can opt to have a single login for their clients using a module that facilitates logins to multiple discrete sites with a single login. This option may be chosen if clients have to log into the hosting company's website, but then would not have to separately log into their account. For example, a client logs onto their online bank account and then can have access to their document management system account without an additional login being necessary.

Also using the deploy quadrant 106, hosting companies can offer a “concierge” service to their client whereby the hosting company will administer the account by managing all documents uploads and all other features for the client. A third party administrator can offer a Concierge program for the account holders in their office/home, over the phone or via a webinar connection, for example.

Using the deliver quadrant 104 functionality for example, hosting company administrators can have automated emails go out to clients notifying them that documents have been stored in their document management system account. The notification states the title of the document, the location (Box, Category and Subcategory) of the document and the time is was uploaded. In some embodiments, for hosting companies that want to have light administration of the system, clients can complete their own profiles and set up their own accounts on the hosting companies private labeled access site.

In some embodiments, using the deposit quadrant 102 functionality for example, hosting company clients can upload, and store permanently, their own documents into their accounts separate from the hosting company. In some embodiments, hosting company clients can add additional boxes in their account, and manage their box inventory themselves. Furthermore, hosting company clients can customize SecureDock boxes, categories and subcategories to use for their account. This would be in addition to the predesigned boxes, categories and subcategories. Moreover, hosting company clients can move, rename and delete documents from their account. Using the deliver quadrant 104 functionality for example, hosting company clients can distribute documents to third parties via an electronic link whereby they can set the expiration of time of the link to a choice of pre-set times, or one of their own design. For example, the link could expire in 1 hour, 2 hours, 4 hours, 6 hours, 8 hours, 12 hours, 24 hours, 2 days, 3 days, 4 days, 5 days, 6 days, 7 days, 2 weeks, 3 weeks, 1 month, 2 months, 3 months, or more, or instantly in some embodiments. The client's account can be configured to keep record of all documents that are distributed from the account. If a document has been distributed by the client, and the client then decides they do not want the recipient of the document to receive the document, if the link is still within the active time period, the client can click a function that immediately expires the link.

Using, for example, the deliver quadrant 104 functionality, When a client distributes a document and the recipient receives the document, the link can be configured to expire even if it is still within the time period prescribed for the link. In some embodiments, each unique link can only be opened once.

Using, for example, the deposit quadrant 102 functionality, hosting company clients can send invitations to outside parties directing them to go to a website page that allows the outside party to upload a document directly into the clients' document management system or their standard email account from the invitation. In some embodiments, no account setup or password is required by the outside party. A manifest can be delivered with the document recording who sent the document, the time and date the document was sent, and/or the title of the document, among other information. The client can have the ability to set the life of an “active link” for a “one time use” to a longer period of time, such as time periods disclosed elsewhere herein. The client can expire the active link at any time. In some embodiments, the sender of the document/file will not have access to the account in any way. The client's account keeps records of all documents received into the account.

Also disclosed herein is a quick login functionality. A document management system account can be set for quick login whereby the account holder only has to put their password in to reopen the account after it times out. At the initial login for a specified period of time (e.g., every day for example) the account holder may need to use their username, password and complete an image code for a successful login. Then when the account is set for Quick Login, the account holder only has to enter the password when the system times out. Once the system times out, the user is sent to a separate login page which only requires the user's password. This can be done through the application, e.g., on the document management system server, for example and not through the client's Internet browser. As such, the quick login functionality is advantageously independent of Internet browser cookies or other settings. In some embodiments, the quick login can be maintained for a specified time period as long as the client's IP address or other identifying information remains the same. After a selected period of time, such as each evening for example, the system logs are cleared, so the account holder would have to complete the whole login system for the next time period.

Also disclosed herein is an electronic passport module, such as a medical passport module. Account holders can be given a physical card that is carried on their person, e.g., in their wallet, or electronic medical passport card (e.g., contained in a mobile application, such as a smartphone application) that they carry in their wallet. The card can have medical information on it useful in a health event (and/or serves as a gateway to access the information electronically), or another type of information suitable for limited distribution according to the client's desired result. In some embodiments, the card provides a mechanism for a first responder to enter their document management system account for additional information. The first responder is given access to the user's account (e.g., limited to their medical information folder within their account) by, for example: login with the login credentials on the card; send a SMS text to a pre-determined number to receive a URL through which the first responder gets access to the client's first responder information without having to log into the account, or get access to any other information in the account; call a toll free or other telephone number; scanning a QR code on the card which provides a link to the medical information on the account, or the like. In some embodiments, the medical passport card can interface with an application, such as a mobile application configured to provide the selected information from the client's document management system account. The information could include, for example, any combination of the client's name, emergency contact(s) name and contact information, past medical history, past surgical history, medication list, allergies, family history, social history, blood type and/or other laboratory information, and the like. In some embodiments, the application includes a module that is configured to activate emergency medical services (e.g., 911), call the clients' emergency contact information, and the like, such as, for example, in a box that can be activated (e.g., from a touchscreen) as soon as the account is accessed from the medical passport card. In some embodiments, once in the account the first responder is given the option to have the expanded medical information emailed to him; the first responder is given the option to have any additional documents stored in the First Responder Box emailed to them; the first responder can call or text a number such as a toll-free number to access the information in the First Responder Box; and/or an email is sent to the account holder notifying them the account has been accessed.

A benefit of some embodiments is to provide a secure location for hosting company's clients to have access to permanently store strategic documents which is available to them twenty-four hours a day, every day, regardless of the end user's geographical location.

Another benefit of some embodiments is the hosting company, through its administrative site, can keep the account up to date in relation to the documents the hosting company does for the client.

Another benefit of some embodiments is that the service offered is permanent storage of the strategic documents for the end user. This is different from software portals that offer temporary storage for a specific purpose.

Another benefit of some embodiments is that the hosting company's clients are in control of the account such that they can upload documents, move or delete documents, set their documents as private, and utilize other functionalities of the system separate and apart from the hosting company.

Another benefit of some embodiments is the user-friendly interface which allows end users without technical expertise to use the systems and methods using only a standard Internet browser (e.g. Mozilla Firefox, Internet Explorer, Chrome, Safari). This is as opposed to requiring an end user to install proprietary software onto a computer in order to use an account.

Another benefit of some embodiments is that an organization scheme is predesigned and provided to the end user, instead of requiring the end user to devise an organizational scheme on their own time and initiative. Furthermore, through a hosting company, there is the option for administrators to store documents for an end user which are placed in appropriate places within the organizational scheme, further lessening the organizational burdens on the end user.

Another benefit of some embodiments is that end users who want to handle and control the uploading and storing of their documents have the ability to do so within the predesigned structure, or to create a customized structure.

Another benefit of some embodiments is, as a website application, it allows end users to delegate security responsibilities to the secure document management system. Most end users lack the expertise or time to stay current with the latest developments in security and security technologies.

Another benefit of some embodiments is the application encrypts all documents concurrently as they are uploaded, and all documents stay encrypted as long as they remain stored by the application.

A further benefit of some embodiments is it provides hosting company clients, end users, with a means of sharing documents with third parties, without sacrificing security, instead of requiring end users to provide complete access to an account to third parties when an end user desires to share a single document. In some embodiments, end users can simply send e-mails or other notifications to outside parties that contain electronic links which allows the outside party to access that document only, or a subset of documents. For additional security each link can be set for a time period of extinction, and can only be used once.

Another benefit of some embodiments is that end users and hosting companies can provide access to a website where documents can be uploaded and delivered into their respective secure document management system inbox, thus allowing them to receive documents in a secure manner. Each document can be delivered with a manifest stating the sender's name, time and date the document was sent, and the document title.

Another benefit of some embodiments is that each client account keeps dated records of all documents that have been distributed, and whether those documents were received and opened by the recipient.

Another benefit of some embodiments is that each client account keeps dated records of all documents that have been received into the account inbox.

Another benefit of some embodiments is that on the hosting company's administrative side, administrators can create multiple client profiles at one time, saving the hosting company administrative time and cost.

Another benefit of some embodiments is that on the hosting company's administrative side, administrators can send out communications to multiple clients at one time, saving the hosting company administrative time and cost.

Another benefit of some embodiments is that on the hosting company's administrative side, administrators can activate multiple client accounts at one time, saving the hosting company administrative time and cost.

Another benefit of some embodiments is that on the hosting company's administrative side, administrators can send out multiple initial credentials for clients to log into the system for the first time, at one time, saving the hosting company administrative time and cost.

Another benefit of some embodiments is that on the hosting company's administrative side, administrators can upload documents to multiple clients at one time, saving the hosting company administrative time and cost.

Another benefit of some embodiments is that the application can accept a wide range of types of file formats (e.g., PDF, JPEG, TIFF, DOCX, and the like).

In some embodiments, a secure document management system can include any number of the following computer-implemented features or combinations of features. Hosting companies, for example, can utilize such systems to store strategic documents for their clients as a service of the company. In some embodiments, the system includes a module that allows a hosting company administrator, through an administrative website, complete a client profile, edit the profile, assign a client ID and username. In some embodiments, the system includes a module that allows the hosting company administrator to set the billing status for the account. Accounts can be set as Internal, whereby the system will bill the client via credit card, or External, whereby the system will not bill the client. This can be done the same way for all clients or done on an individual bases. The hosting company administrator can send credentials for a client to log onto their account the first time. Credentials can be sent in the same or in a plurality of communications, e.g., emails, one containing the client's username and one containing the client's temporary password. In some embodiments, the system can allow the hosting company administrator to add folders or boxes to the client's account. These can be predesigned boxes or custom boxes. The system can allow the hosting company administrator to set the billing information for the client, should that be required. In some embodiments, the system can allow the hosting company administrator to upload documents to the client's account, placing the documents in predesigned or customized categories or subcategories. The system can be configured to check that each document that is loaded has a unique document title. Also, the system can allow the hosting company administrator to see all the documents that are currently loaded in a particular box within the secure document management system, such as on the page where documents are uploaded.

Also disclosed herein is a system configured to allow the hosting company administrator to see on one webpage a list of clients, where one is highlighted, the administrator can see what boxes have been added, what documents have been added, the details of the client profile, details of the boxes added, details of the documents added, and the ability to view the documents if that function is enabled. The system can allow the hosting company administrator to search for a particular client by using a “Go To” button or “Search” button, for example. The system can also allow the hosting company administrator to add additional administrators with multiple levels of access, delete administrators or inactivate an administrator, and/or create administrative passwords and edit passwords.

The system can also allow the hosting company administrator to utilize batch functionality where administrators can upload data to complete multiple client profiles at one time as described elsewhere herein. The batch functionality can allow administrators can communicate via email with all clients, or and number of clients they choose with one function; set multiple client accounts as active or inactive with one function; send out initial log in credentials to multiple clients on the system with one function; and/or upload a document to multiple clients on the system with on function. In some embodiments, the system can allow the hosting company administrator to set up an account recipient list(s) and add recipients to each list, and/or add a recipient on more than one recipient list.

In some embodiments, the hosting company can have a private labeled website where outside parties can visit and see specific recipient lists, choose a recipient, and upload a document for that recipient. The document is then sent, via electronic link, and uploaded to the recipient's secure document management system account or their standard email inbox. A manifest can be delivered with the document stating who the sender is, the time and date the document was sent, the title of the document, and/or other information. An email receipt is sent to the sender, and an email is sent to the recipient stating the document has been uploaded to their account.

In some embodiments, the recipient of a document uploaded to their account via a sender utilizing a secure web link can view a history of all documents received by their Inbox or standard email inbox.

In some embodiments, the system includes a module that allows the hosting company administrator to access a report page to view quick reports, client details and revenue reports.

In some embodiments, the client of a hosting company can have access to a private label website and complete a client profile, creating an account. The client of a hosting company can send, from their profile, the initial credentials to log into their account for the first time. The client of a hosting company can add boxes (e.g., of specific categories of files) to their accounts, either the predesigned boxes or a custom box. Clients can manage their Box inventory through, for example, adding, deleting and renaming their Boxes, and can upload documents into a box in their secure document management account in a predesigned category and subcategory or a custom category and subcategory. In some embodiments, a system includes a module that allows a client of a hosting company to click on a particular category in an opened box and view all the stored documents in the center panel, and/or click an Expand All function and have all the documents stored in the box shown in the center panel. The client can select a document and have the options to view/print/download/delete or set the document to private.

In some embodiments, the system allows a client to select a document and distribute the document via an electronic link to an outside party. The duration of the link can be set for any particular time disclosed herein or a custom time selected by the client. The system can allow the client to have records kept of all documents distributed from the account, showing the date sent, time sent, who it was sent to, the status of the document (received, expired (not opened) or live) and the title of the document, among other information. The system can allow the client to click a function to expire a live link of a document distributed; delete, move or rename a document; and/or to restore a document that was deleted within a specified time period from the deletion, such as, for example, within about 1 hour, 2 hours, 4 hours, 6 hours, 8 hours, 12 hours, 24 hours, 2 days, 3 days, 4 days, 5 days, 6 days, 7 days, 2 weeks, 3 weeks, 1 month, 2 months, 3 months, or more.

In some embodiments, the system can allow a client to send an invitation to an outside party to visit a website in order to upload a document that will be delivered into the client's secure document management system inbox or their standard email inbox. This document can be delivered with a manifest stating who send the document, the date and time the document was sent and the title of the document. The sender of the document can receive an email receipt of the document being sent with the same manifest information. In some embodiments, the sender of the document(s) is never given access to the accountholder's document management system in any way.

Also disclosed herein is a system having a module configured to send an invitation to an outside party to visit a website to upload a document that will be delivered into the client's secure document management account inbox or their standard email inbox. The link sent can be designed to be a one-time use, a limited plurality of number of uses, or a multiple use link for a longer duration of time. The client can expire a live link at any time. The client can receive an email notification that a document has been delivered to their secure document management account inbox or standard email inbox.

In some embodiments, the system can have a module configured to maintain a record of all documents that have been delivered into their SecureDock Inbox or standard email inbox. The record will show the sender's name, email, date and time the document was sent and the title of the document.

In some embodiments, disclosed is a system that allows a client of a hosting company to carry a medical passport card that provides a first responder helpful information in a health event. The card provides one, two, or more ways for the first responder to receive additional information, including, for example, 1) via login credentials on the card, 2) via a SMS text that provides a link for the first responder to enter directly into the card holder's first responder account, 3) scanning a QR code, and 4) via a toll free telephone number. Once in the account holder's first responder box, the first responder has the option to have all the expanded medical information emailed to them, and the option to have additional documents stored within the First Responder Box emailed to them. The account holder can be notified that the account has been accessed.

Also disclosed herein is a system having a module that allows a client to set their secure document management system account for Quick Login whereby the account holder only has to put their password in to reopen the account after it times out. At the initial login each day the account holder needs to use their username, password and complete an image code for a successful login. Then when the account is set for Quick Login, the account holder only has to enter the password when the system times out. Once the system times out, the user is sent to a separate login page which only requires the user's password. This is done through the application, not through the browser. After a specified period of time, e.g., each evening the system logs are cleared, so the account holder would have to complete the whole login system the next day.

The system can include a module to ensure the client's account documents are no longer within the system or its backups. When a client no longer wants to have their documents stored on the system, the system can ensure their documents have been erased along with a comprehensive search to prove their files were expunged. The system can then issues a Clean Vault Certificate to the client to ensure them their documents have been erased from the system, that the search has been completed, and showing them their files no longer exist on the system.

These and other features will become apparent from the following description when taken in conjunction with the claims and drawing figures herein described.

### BRIEF DESCRIPTION OF THE DRAWINGS

FIG. 1 presents a flowchart to illustrate the steps taken to create an account on the Administrative site by a host company administrator, according to some embodiments of the invention, and shows some possible ways to create an account. Disclosed herein is an online, cloud based document and knowledge management system that works, in some embodiments in a continuous process or flow with a number of modules, stages, or quadrants. FIG. 1A illustrates a schematic of one embodiment of the modules.

FIG. 2 presents a flowchart to illustrate the steps taken to create an account on the Client site by the client of a hosting company, and shows some possible ways to create an account.

FIG. 3 (separated into upper and lower halves for readability, FIG. 3A representing the upper half of the flow chart and FIG. 3B representing the lower half of the flow chart) presents a flowchart of some non-limiting functionalities the hosting company administrator, on the Administrative site, can utilize, including one or more of the following: (a) an administrator can complete a client profile and send a client temporary credentials to access their account, reset passwords, set charges, if required, for the client, delete the client; (b) administrator can add unlimited electronic boxes for the client choosing from predesigned templates or a customized box, titles the box and sets billing information as required; (c) administrator can upload documents on behalf of the client into their specific electronic boxes, choosing predesigned categories and subcategories, or create customized categories or subcategories, can edit, move or delete documents; (d) administrator can review the details panel for information for the client profile, chosen box or chosen document; and (e) administrator can view the document selected should that functionality be enabled.

FIG. 4 (separated into upper and lower halves for readability, FIG. 4A representing the upper half of the flow chart and FIG. 4B representing the lower half of the flow chart) presents a flowchart of some non-limiting additional functionalities the hosting company administrator, on the Administrative site, can utilize. For example, an administrator can add new administrators at multiple levels of accessibility. An administrator can use the Batch functionalities, including but not limited to (1) upload data information to complete multiple client profiles at one time; (2) send out correspondence to multiple clients at one time; (3) activate multiple clients at one time; (4) send out multiple initial credentials for clients to log onto the system for the first time; (5) upload a document to multiple clients at one time; (6) set up an inbound and/or outbound recipient list and add recipients to each list; (7) access reporting features, such as quick reports on data location and size, client profile details, and/or revenue reports; and/or (8) set billing for an individual client or all clients for a hosting company.

FIG. 5 (separated into upper and lower halves for readability, FIG. 5A representing the upper half of the flow chart and FIG. 5B representing the lower half of the flow chart) presents a flowchart of functionalities that the hosting company client can access on the private labeled client site, according to some embodiments. Functionalities can include, for example, that (1) client adds, names and edits a predesigned or customized electronic box; (2) client adds, names and edits predesigned categories and sub-categories or creates customized categories and subcategories; (3) client can upload documents into the predesigned editable categories and subcategories or upload documents into the customized editable categories and subcategories; (4) client selects a document and can view or print the document; download the document to the computer they are using; distribute the document to an outside party through electronic link assess; move or rename document; delete document through a recycle bin; recover a deleted document from the recycle bin within a specified, e.g., two week timeframe; (5) client can send an invitation to an outside party for the outside party to send the client a document that can be delivered into the client's secure inbox via an electronic link. No account set up or password may be necessary for the outside party.

FIG. 6 presents a flowchart of hosting companies utilization of receiving documents through an inbound functionality module, according to some embodiments of the invention.

FIG. 7 presents a flowchart of client end users utilization of receiving documents through an inbound functionality module, according to some embodiments of the invention.

### DETAILED DESCRIPTION

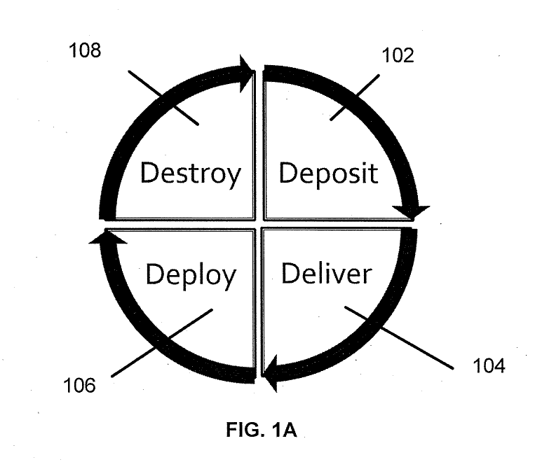

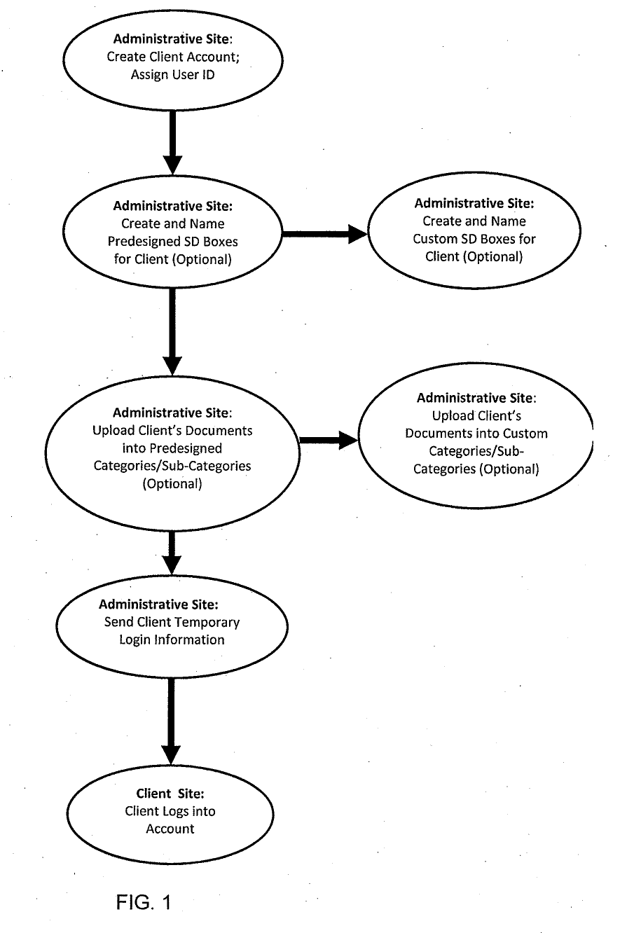

Disclosed herein is an online, cloud based document and knowledge management system that works, in some embodiments in a continuous process or flow with a number of modules, stages, or quadrants. FIG. 1A illustrates a schematic of one embodiment of the modules. In the deposit stage 102, similar to money in a savings account, the system accepts strategic documents, photos and other digital assets into a user account. Until withdrawn by the user to be delivered, deployed or destroyed, in some embodiments nothing flows to the other three quadrants. In the deliver stage 104, like a checking account, system users execute transactions, including one-time, separate on line transactions for a specific purpose. In the deploy stage 106, like a money market account, system users arrange access to their documents over specific times, in collaboration with advisors and across multiple family generations. In the destroy stage 108, like paper money or any document, system users can authorize their strategic documents to be expunged from the cloud based storage and back up vaults in a guaranteed fashion.

In some embodiments, systems and methods as disclosed herein offer to hosting companies the benefits of company branding through the private labeling of the client account access site and inbound access site, as well as the internal pages of those sites. Additional benefits are cost savings from the Batch functions, and a company revenue source should the hosting company choose to ask for payment to use the system.

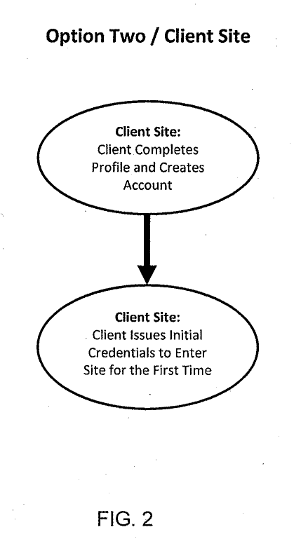

FIGS. 1 and 2 are flowcharts describing steps of the hosting Company or Client options to create an end user account, according to some embodiments of the invention.

Referring to FIG. 1, an account is created through a hosting company's administrator on the company's administrative site on a local computer. The administrator creates a profile for the client, can add predesigned or customized safe deposit boxes to the account, can upload documents into the account in predesigned categories or subcategories or customized categories and subcategories. The administrator then sends the client the initial credentials to log into the account for the first time. These tasks can be done in this order, but can also be done in differing orders. The adding safe deposit boxes and uploading documents are optional as the end user can also do these functions.

In some embodiments, there are one, two, three, or more predesigned electronic boxes that can be added to each account, such as an “Individual Box”, “Business Box”, “Trust Box”, “Medical Box”, “First Responder Box”, “Legacy Box”, “Diary Box”, and the Gratitude Grid Box.” Each of these can contain numerous categories and subcategories. These predesigned boxes give the end user an account that is ready to use without work on their part. However, each account can have customizable boxes as well as customizable categories and subcategories. The number of boxes that can be added to each account can be unlimited. Each box can have a unique level of access to any number of third parties specified by the user, for example, a user can allow a box pertaining to financial documents to be shared with the user's accountant but not other personal boxes.

Referring to FIG. 2, in some embodiments an account is created by the hosting company's client, end user, themselves on the private labeled client site. The end user completes a client profile, activates and sends themselves the initial credentials for their initial login.

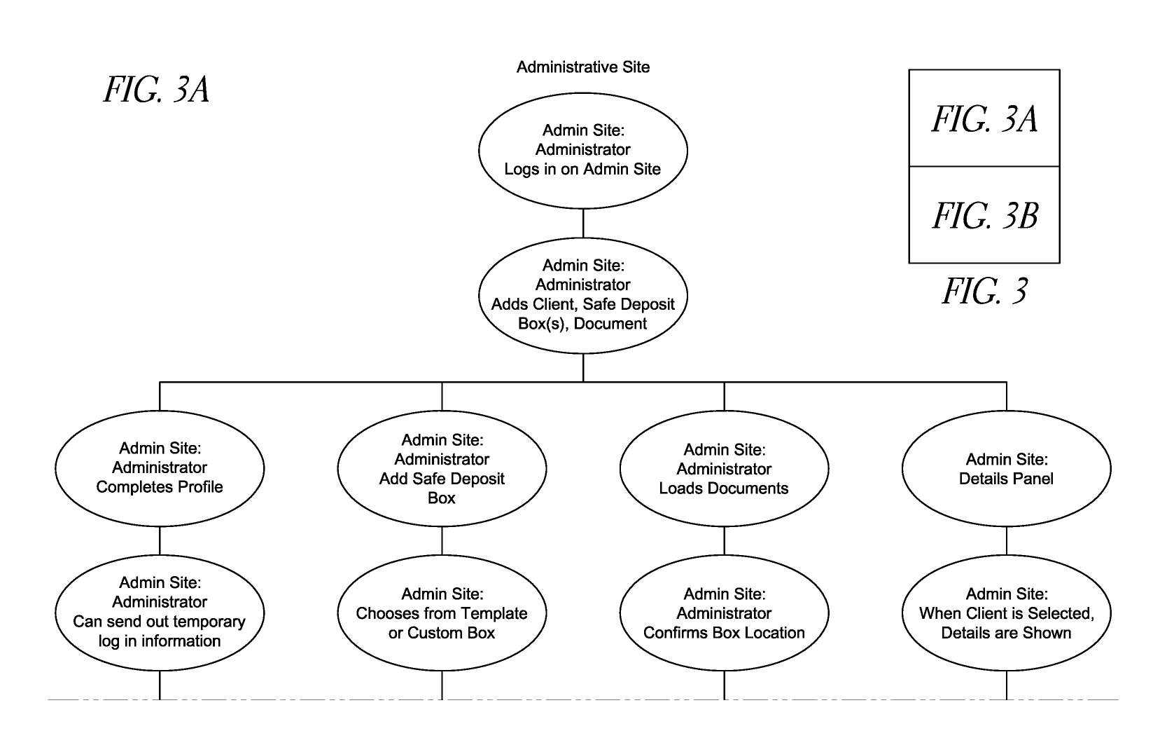

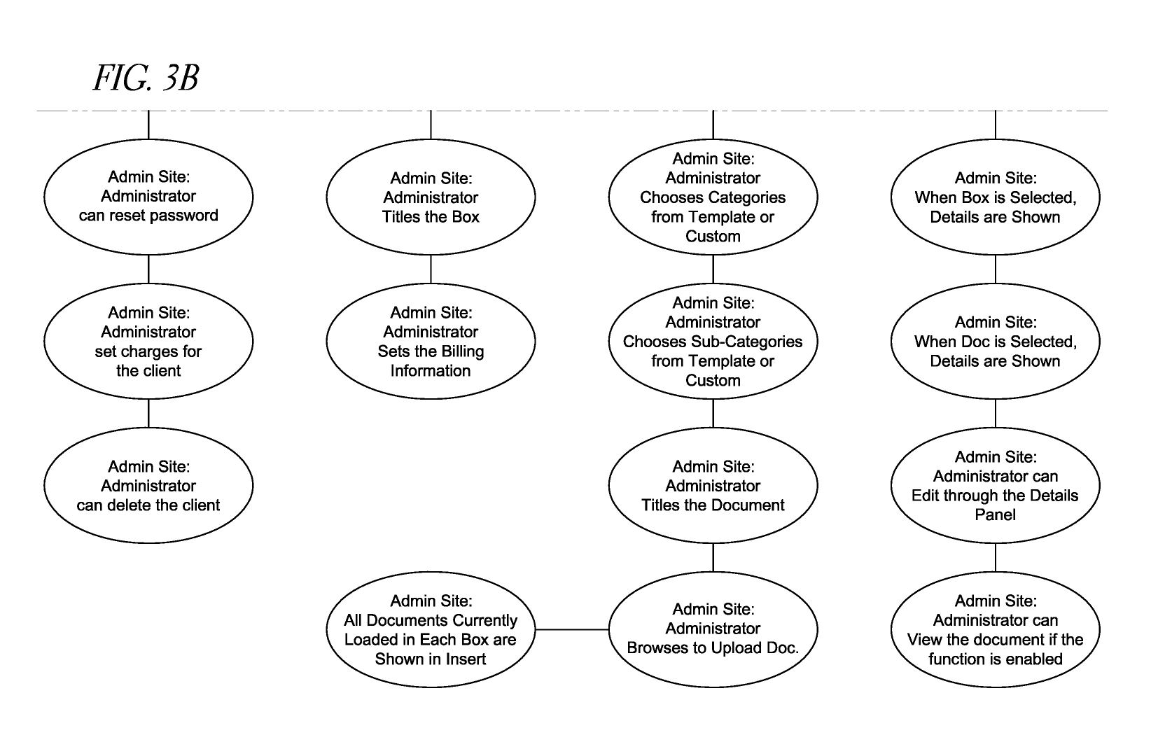

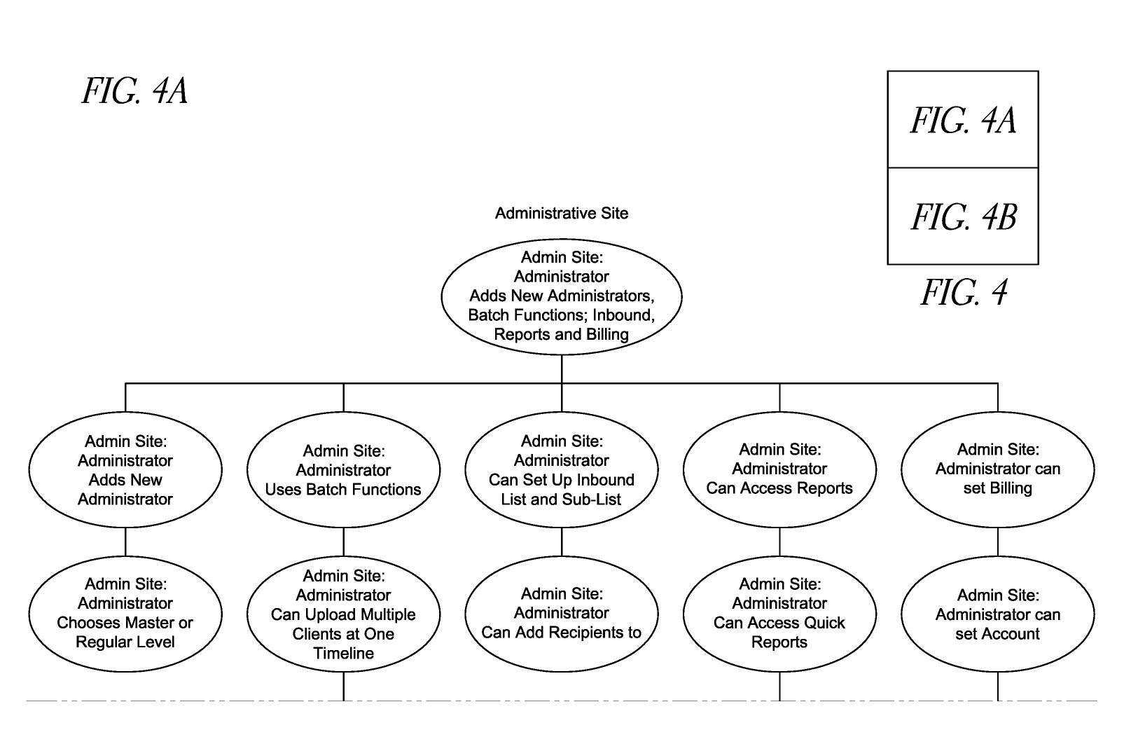

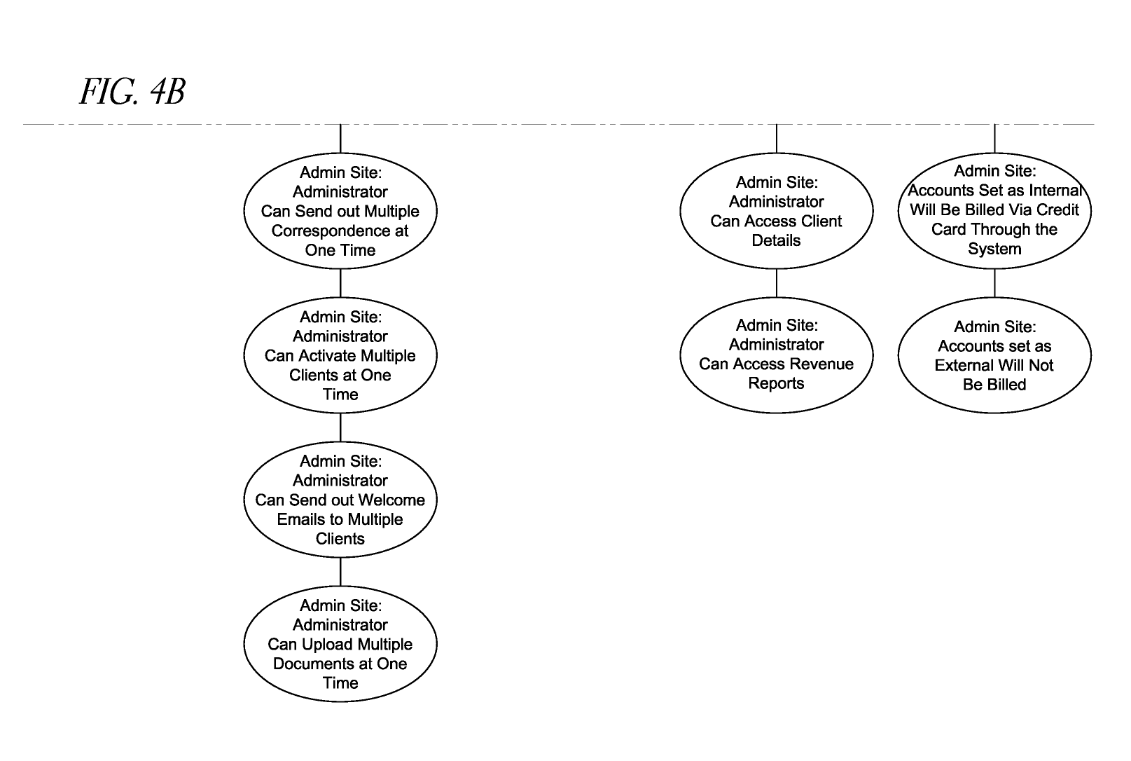

Referring to FIGS. 3 (divided into FIGS. 3A-3B) and 4 (divided into FIGS. 4A-4B) the hosting company's administrator has multiple functionalities as outlined herein, according to some embodiments of the invention.

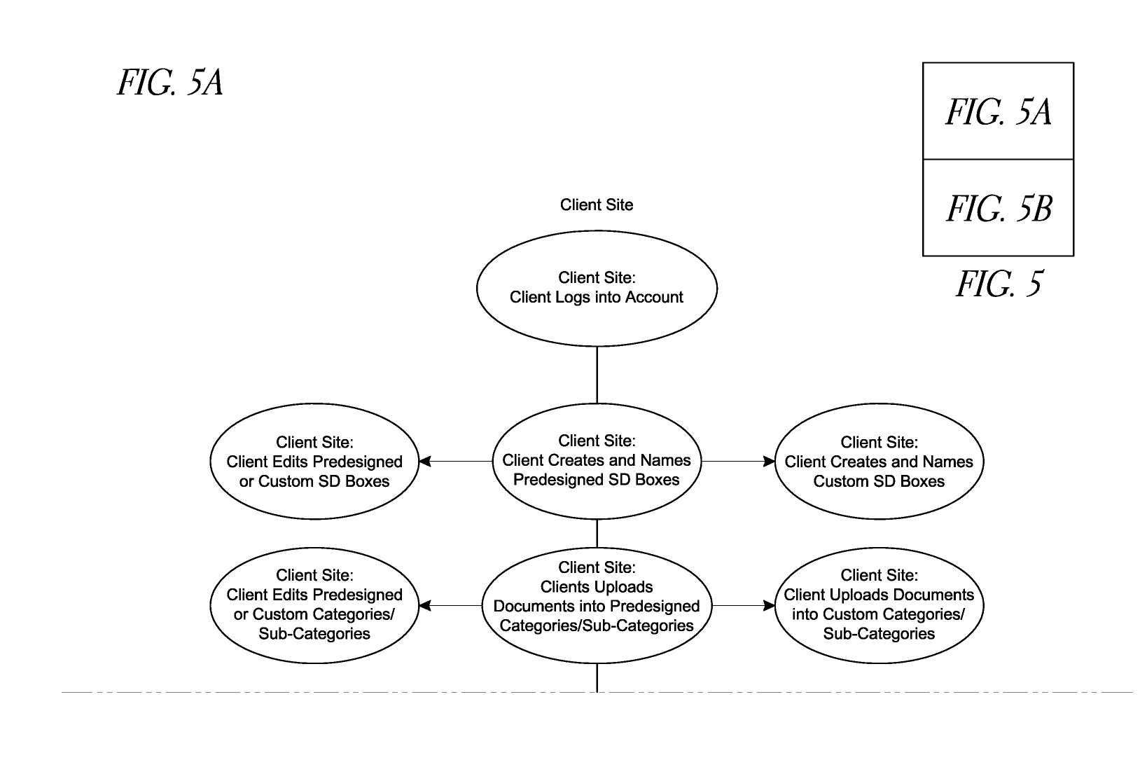

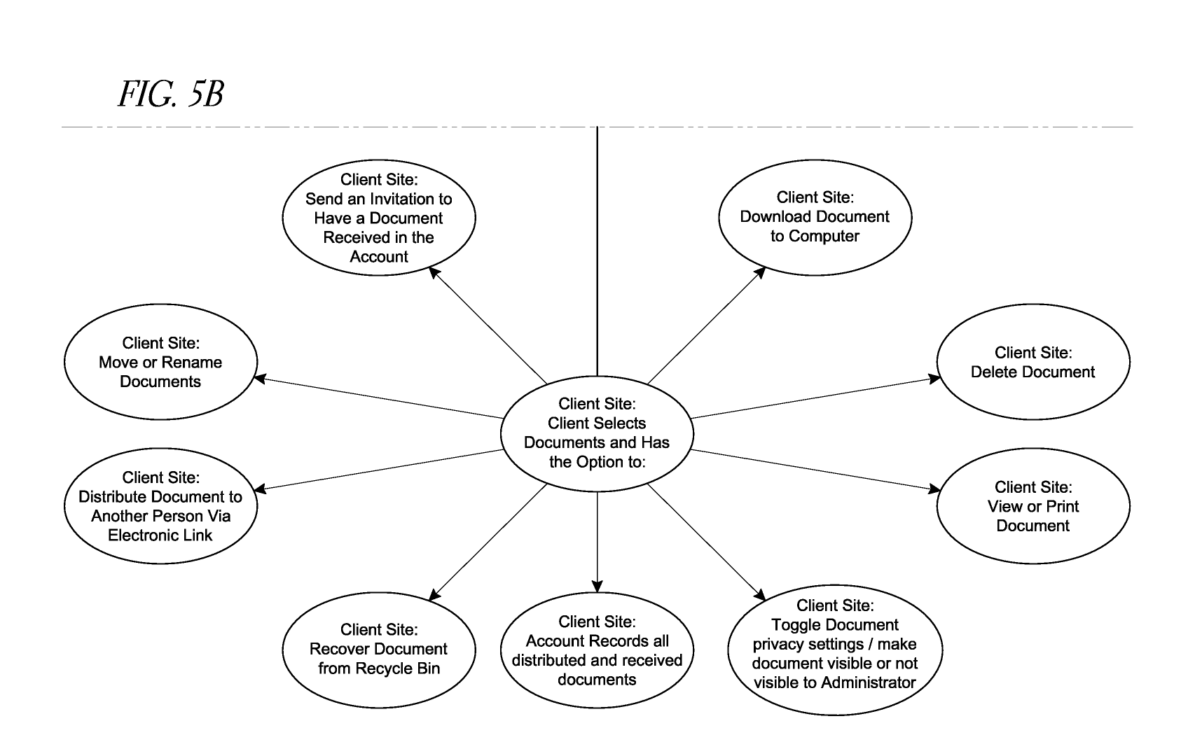

Referring to FIG. 5 (divided into FIGS. 5A-5B) the end user has multiple functionalities as outlined herein, according to some embodiments of the invention.

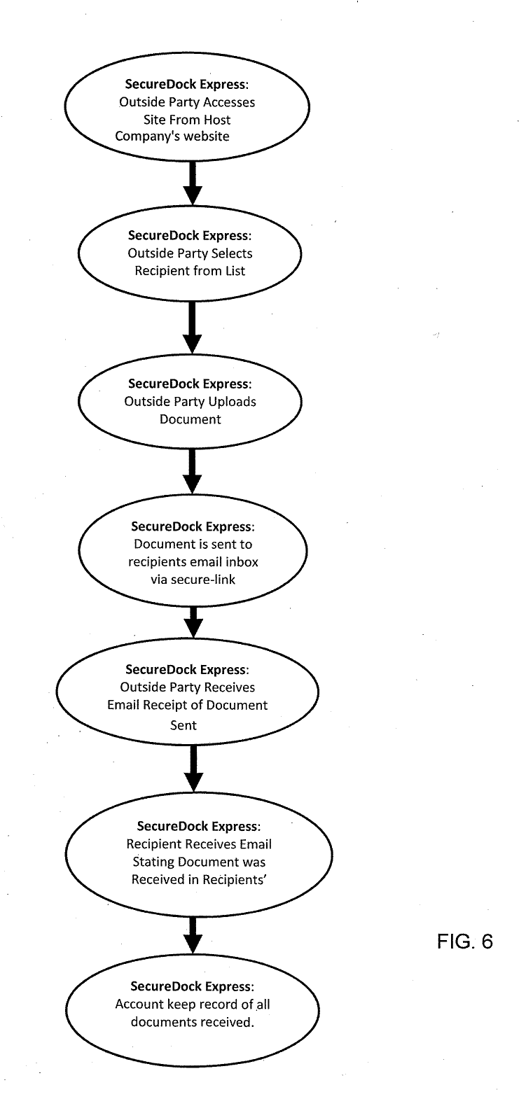

Referring to FIG. 6 the hosting company can create a SecureDock Express recipients list(s) as one of the functionalities described above. Once that is done the Express can be used as illustrated as outlined herein, according to some embodiments of the invention.

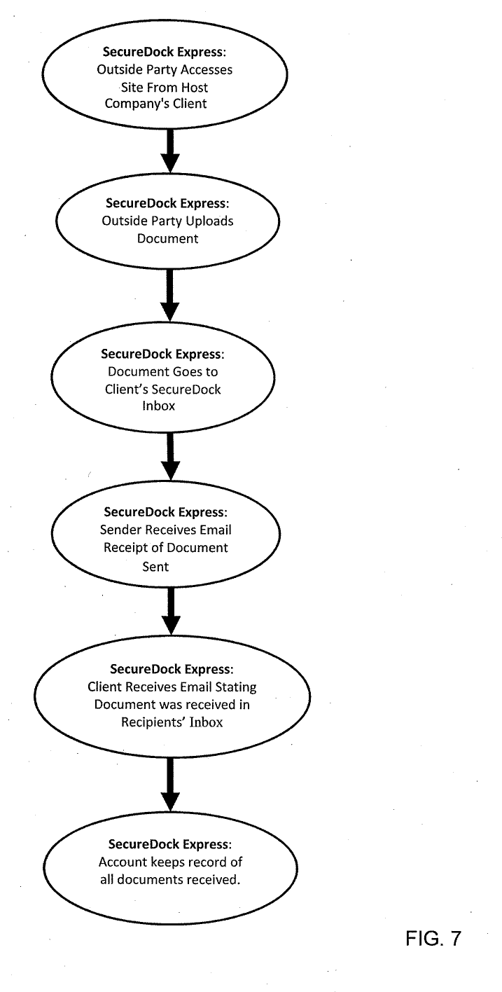

Referring to FIG. 7 the end users have the ability to access a site so that documents can be received by them into their SecureDock Inbox as shown as outlined herein, according to some embodiments of the invention.

Disclosed herein are computer-implemented systems and method for hosting companies to store strategic documents for their clients as a service of the company. The systems and methods could comprise one or more of the following, including any combinations and subcombinations thereof.

In some embodiments, a conventional login can require a User ID and password be assigned to an end user at the time the account was created. When the end user attempts to access the account (or “login” to the account), an end user is asked by one of the webpages to input said user identification or “User ID” and said password. The inputted User ID and password are checked against the User ID and password previously assigned to the end user. If there is a match, a randomly generated set of characters are displayed on the end user's monitor, and the end user is asked to correctly input said random set of characters. This latter test prevents automated software from performing actions which degrade the quality of service; for example, it prevents “robot”-type software-driven logins that are typical of internet “spam” or intruders. This random-image system is also known as a CAPTCHA (“Completely Automated Public Turing test to tell Computers and Humans Apart”) challenge-response test. In some embodiments, a TLS (Transport-Layer Security) “certificate” or SSL (Secure Sockets Layer) “certificate” is used to preserve the security of the above-described “login” by the end user; said certificates involve cryptographic protocols which protect against several well-known attacks frequently used by third-party intruders. In some embodiments, if the end user has inputted the correct user ID and password, and has satisfied said random image generation test, the end user is authenticated. If the user's identity cannot be authenticated, further access is not allowed by the system.

In some embodiments, repeated conventional logins to an account over a short period of time can potentially be cumbersome. For clients, or advisors who are using the secure document management systems to store and distribute documents for their clients, in some embodiments the system includes a module such that they can set their login screen so when the system times out, they are taken to a separate login screen where they can log back in by only putting in their password. The username and CAPATCHA fields do not appear. The login page can be set to this setting for a predetermined time period, such as every 24 hours. Disclosed herein is a quick login functionality. A document management system account can be set for quick login whereby the account holder only has to put their password in to reopen the account after it times out. At the initial login for a specified period of time (e.g., every day for example) the account holder may need to use their username, password and complete an image code for a successful login. Then when the account is set for Quick Login, the account holder only has to enter the password when the system times out. Once the system times out, the user is sent to a separate login page which only requires the user's password. This quick login functionality can be done through the application, e.g., on the remote host's document management system server, for example and not through the client's Internet browser. As such, the quick login functionality is advantageously independent of client Internet browser cookies, closing and reopening the browser which can reset the browser, or other settings on the client's computer. In some embodiments, the quick login can be maintained for a specified time period as long as the client's IP address or other identifying information remains the same. After a selected period of time, such as each evening for example, the system logs are cleared, so the account holder would have to complete the whole login system for the next time period.

Also disclosed herein is an electronic passport module, such as a medical passport module. Account holders can be given a physical card that is carried on their person, e.g., in their wallet, or electronic medical passport card (e.g., contained in a mobile application, such as a smartphone application) that they carry in their wallet. The card can have medical information on it useful in a health event (and/or serves as a gateway to access the information electronically), or another type of information suitable for limited distribution according to the client's desired objectives. In some embodiments, the card provides a mechanism for a first responder to enter the account holder's document management system account for additional information. The first responder is given limited access to the user's account (e.g., limited to their First Responder medical information folder within their account) by, for example: login with the login credentials on the card; send a SMS text to a pre-determined number to receive a URL through which the first responder gets access to the client's first responder information without having to log into the account, or get access to any other information in the account; call a toll free or other telephone number; scanning a barcode, QR code, RFID chip, magnetic strip, or other feature on the card which provides a link to the medical information only on the account, or the like, without requiring the user or the first responder to utilize the user's login credentials. In some embodiments, the medical passport card can interface with an application, such as a mobile application configured to provide the selected information from the client's document management system account. The information could include, for example, any combination of the client's name, emergency contact(s) name and contact information, insurance information, primary care and/or specialty care physician information, advance directives, do not resuscitate documentation, health care power of attorney information, past medical history, past surgical history, medication list, allergies, family history, social history, blood type and/or other laboratory information, and the like. In some embodiments, the application includes a module that is configured to activate emergency medical services (e.g., 911), call the clients' emergency contact information, call the client's physician, and/or the like, such as, for example, in a box that can be activated (e.g., from a touchscreen) as soon as the account is accessed from the medical passport card. In some embodiments, once in the account the first responder is given the option to have the expanded medical information emailed, texted, or otherwise communicated to him; the first responder is given the option to have any additional documents stored in the First Responder Box within the user's document management account emailed, texted, or otherwise communicated to them; the first responder can call or text a number such as a toll-free number to access the information in the First Responder Box; and/or an email is sent to the account holder notifying them the account has been accessed. The system can prompt the user ahead of time and allow the user to consent that the medical or other information stored in the first responder's box will be used by the first responder and can be considered public information.

Disclosed herein are systems and methods for a client of a hosting company to ensure their documents are no longer stored (e.g., that they are securely and permanently deleted) within the system including all of its backups. When a client no longer wants to have their documents stored on the system, the system ensures their documents have been erased along with a comprehensive search to prove their files were expunged. The system then issues a notification, such as a Clean Vault Certificate to the client to confirm to them that some or all of their documents have been erased from the system, that the search has been completed, and showing them their files no longer exist on the system. In some embodiments, a system for secure data deletion and notification includes a primary data store that stores a current version of an electronic file of a user within a secure account of the user. The system can also include one, two, or more backup data stores that stores the current or a previous version of the electronic file of a user. The version of the file on the backup data stores could be current (e.g., a real-time mirrored backup of the primary data store, or as of the last edited date and time of the primary data store) and/or the backup could be a pure chronological backup of the client's account or a file or subset of files in the client's account as of a specified date and time, such as, for example, a minute, an hour, 2 hours, 4 hours, 6 hours, 8 hours, 12 hours, 24 hours, 2 days, 3 days, 1 week, 2 weeks, 1 month, 2 months, 3 months, or more earlier than the primary data store. The system can also include a deletion module configured to receive a request from a user to securely delete the electronic information from the primary data store and/or backup data stores. In some embodiments, only the primary data store is deleted and the backup data stores are overwritten at specified time intervals. Also disclosed herein is a search module configured to attempt to locate the electronic information of the user on the data store and the one, two, or more backup data stores, and send a confirmation that the electronic information of the user is either found or no longer found on either the data store or the backup data stores. The search module can also include a recovery module that can, in some embodiments, attempt to recover the file if, for example, metadata associated with the file has not been deleted, or the file is partially recoverable, and send deletion confirmation only if the file is not recoverable. In some embodiments, the search module can communicate with the deletion module to securely and permanently delete the file on the primary data stores and/or backup data stores, and be configured to do a 1-pass, 2-pass, 3-pass, 4-pass, 5-pass, 6-pass, 7-pass, or more wipe, including a file or account wipe corresponding to U.S. Department of Defense 5220.22-M standards. Further disclosed herein is a communications engine configured to receive the confirmation from the search module that the electronic file or information of the user is not found, and upon receipt of the confirmation electronically communicate to the user a certification of secure deletion of the electronic file, groups of files, or the entire user's account. The certification of deletion can indicate that the data store and at least one or all backup data stored no longer contain the electronic file(s), and the electronic file(s) has been securely deleted. The communication can be, for example, via email, text message, phone call, printed letter, or the like. The system can be configured to send the communication of deletion to the user automatically after the deletion request by the user. In other embodiments, the user can request the communication regarding secure deletion at a future time period chronologically spaced apart from the deletion request, such as, for example, at least a minute, an hour, 2 hours, 4 hours, 6 hours, 8 hours, 12 hours, 24 hours, 2 days, 3 days, 1 week, 2 weeks, 1 month, 2 months, 3 months, or more after the deletion request.

In some embodiments, the document management system includes batch system functionality. Hosting company administrators can utilize batch functions, that is, executing a series of computer-implemented tasks without necessarily requiring manual intervention. In some embodiments, the batch module allows for the creation of multiple accounts. Administrators can upload data to create multiple client profiles, thereby setting up multiple accounts at one time. These accounts can be set up, for example, to bill internally, through the system via credit card, or externally, whereby the system will not bill the client. In some embodiments, using the batch module administrators can set multiple client accounts as active or inactive with a single command function. In some embodiments, using the batch module administrators can send out initial or subsequent login credentials to multiple clients on the system with one function. Furthermore, in some embodiments, administrators can upload or download a particular document or multiple selected documents to multiple clients on the system with one function. The batch module for example, can allow for an administrator to communicate via email with all clients, or a sub-set of clients that they choose (e.g., by selecting for certain client demographic information) with a single function.

In some embodiments, the system include a module that allows hosting company clients to send invitations to outside parties directing them to go to a website page that allows the outside party to upload a document directly into the clients' document management system or their standard email account from the invitation. In some embodiments, no account setup or password is required by the outside party. A manifest can be delivered with the document recording who sent the document, the time and date the document was sent, and/or the title of the document, among other information. The client can have the ability to set the lifespan of an active link for a one-time use, multiple use, and to a longer period of time, such as time periods disclosed elsewhere herein. The client can expire the active link at any time. In some embodiments, the sender of the document/file will not have access to the account in any way. The client's account keeps records of all documents received into the account. In some embodiments, a similar process can be used to allow the client to securely send one, two, or more documents from the client's secure document management account to one or more recipients, and can include the ability to control the lifespan of the link, and manifest information as noted above.

Also disclosed herein is a module that allows an advisor to have his/her clients/associates use a customized secure link on the advisor's website/email signature to upload a document or documents securely into their standard email inbox or their secure document management account inbox without having to create an account or set up a password. Each advisor can have multiple recipient lists, and recipients can be on multiple recipient lists. In some embodiments, the process can involve one or more of the following steps. 1) The user navigates to the advisor's custom branded Express landing page. The user need not enter in their username and password. Instead, they simply use a CAPTCHA to login which is unique at each login and is still secure by virtue of the unique customized link sent by the advisor, for example. 2) Once logged in, the user can select from one or multiple recipients from the advisor's list of applicable contacts. 3) Once the recipients are selected, the user can browse and select (and provide a description) one or more documents to Express Transfer. 4) The user provides their name, email and a message to the recipient. The Express system encrypts the documents, uploads them to a secure server, and sends a secure download link to the selected recipients. In some embodiments, the user is not granted access to the account in which they are uploading the file, and are not able to determine the contents of the account.

The download link and associated files are active for before deactivation. The associated documents are then removed. Express allows the user to select up to a specified number of files, such as up to 2, 3, 4, 5, 10, 20, 30, 40, 50, 75, or 100 files or more with a maximum file or collective file size limit.

In some embodiments, the computer clients and/or servers described above take the form of a computing system that is in communication with one or more computing systems and/or one or more data sources via one or more networks. The computing system may be used to implement one or more of the systems and methods described herein. In addition, in one embodiment, the computing system may be configured to apply one or more of the methods and systems described herein. While an embodiment of a computing system is disclosed, it is recognized that the functionality provided for in the components and modules of computing system may be combined into fewer components and modules or further separated into additional components and modules.

In general, the word “module,” as used herein, refers to logic embodied in hardware or firmware, or to a collection of software instructions, possibly having entry and exit points, written in a programming language, such as, for example, COBOL, CICS, Java, Lua, C or C++ or Objective C. A software module may be compiled and linked into an executable program, installed in a dynamic link library, or may be written in an interpreted programming language such as, for example, BASIC, Perl, or Python. It will be appreciated that software modules may be callable from other modules or from themselves, and/or may be invoked in response to detected events or interrupts. Software instructions may be embedded in firmware, such as an EPROM. It will be further appreciated that hardware modules may be comprised of connected logic units, such as gates and flip-flops, and/or may be comprised of programmable units, such as programmable gate arrays or processors. The modules described herein are preferably implemented as software modules, but may be represented in hardware or firmware. Generally, the modules described herein refer to logical modules that may be combined with other modules or divided into sub-modules despite their physical organization or storage.

In an embodiment, the computing system also comprises an iPhone®, iPad®, or other computing devices suitable for controlling and/or communicating with large databases, performing transaction processing, and generating reports from large databases. The computing system also comprises a central processing unit (“CPU”), which may comprise a conventional microprocessor. The computing system further comprises a memory, such as random access memory (“RAM”) for temporary storage of information and/or a read only memory (“ROM”) for permanent storage of information, and a mass storage device, such as a hard drive, diskette, or optical media storage device. Typically, the modules of the computing system are connected to the computer using a standards based bus system. In different embodiments, the standards based bus system could be Peripheral Component Interconnect (PCI), Microchannel, SCSI, Industrial Standard Architecture (ISA) and Extended ISA (EISA) architectures, for example.

The computing system, in some embodiments, comprises one or more commonly available input/output (I/O) devices and interfaces, such as a keyboard, mouse, touchpad, and printer. In one embodiment, the I/O devices and interfaces comprise one or more display devices, such as a monitor, that allows the visual presentation of data to a user. More particularly, a display device provides for the presentation of GUIs, application software data, and multimedia presentations, for example. In some embodiments, the I/O devices and interfaces also provide a communications interface to various external devices. The computing system may also comprise one or more multimedia devices, such as speakers, video cards, graphics accelerators, and microphones, for example.

Any process descriptions, elements, or blocks in the flow diagrams described herein and/or depicted in the attached figures should be understood as potentially representing modules, segments, or portions of code which include one or more executable instructions for implementing specific logical functions or steps in the process. Alternate implementations are included within the scope of the embodiments described herein in which elements or functions may be deleted, executed out of order from that shown or discussed, including substantially concurrently or in reverse order, depending on the functionality involved, as would be understood by those skilled in the art.

All of the methods and processes described above may be embodied in, and partially or fully automated via, software code modules executed by one or more general purpose computers. For example, the methods described herein may be performed by an analysis system, interactive community platform, and/or any other suitable computing device. The methods may be executed on the computing devices in response to execution of software instructions or other executable code read from a tangible computer readable medium. A tangible computer readable medium is a data storage device that can store data that is readable by a computer system. Examples of computer readable mediums include read-only memory, random-access memory, other volatile or non-volatile memory devices, CD-ROMs, magnetic tape, flash drives, and optical data storage devices.

The computing system may run on a variety of computing devices, such as, for example, a mobile device or a server, a Windows server, an Structure Query Language server, a Unix server, a personal computer, a mainframe computer, a laptop computer, a cell phone, a personal digital assistant, a kiosk, an audio player, a smartphone, a tablet computing device, and so forth. The computing system is generally controlled and coordinated by operating system software, such as iOS, z/OS, Windows 95, Windows 98, Windows NT, Windows 2000, Windows XP, Windows Vista, Windows 7, Windows 8, Linux, BSD, SunOS, Solaris, or other compatible operating systems. In Macintosh systems, the operating system may be any available operating system, such as MAC OS X. In other embodiments, the computing system may be controlled by a proprietary operating system. Conventional operating systems control and schedule computer processes for execution, perform memory management, provide file system, networking, and I/O services, and provide a user interface, such as a graphical user interface (“GUI”), among other things.

In some embodiments, the computing system is coupled to a network 418, such as a LAN, WAN, or the Internet, for example, via a wired, wireless, or combination of wired and wireless, communication link. The network communicates with various handheld devices or other computing devices and/or other electronic devices via wired or wireless communication links. In some embodiments, the network is communicating with one or more computing systems and/or one or more data sources.

Access to the data system module of the computer system by computing systems and/or by data sources may be through a web-enabled user access point such as the computing systems' or data source's personal computer, cellular phone, laptop, or other device capable of connecting to the network. Such a device may have a browser module is implemented as a module that uses text, graphics, audio, video, and other media to present data and to allow interaction with data via the network.

The browser module may be implemented as a combination of an all points addressable display such as a cathode-ray tube (CRT), a liquid crystal display (LCD), a plasma display, touch screen display or other types and/or combinations of displays. In addition, the browser module may be implemented to communicate with input devices and may also comprise software with the appropriate interfaces which allow a user to access data through the use of stylized screen elements such as, for example, menus, windows, dialog boxes, toolbars, and controls (for example, radio buttons, check boxes, sliding scales, and so forth). Furthermore, the browser module may communicate with a set of input and output devices to receive signals from the user.

The input device(s) may comprise a keyboard, roller ball, pen and stylus, mouse, trackball, voice recognition system, or pre-designated switches or buttons. The output device(s) may comprise a speaker, a display screen, a printer, or a voice synthesizer. In addition a touch screen may act as a hybrid input/output device. In another embodiment, a user may interact with the system more directly such as through a system terminal connected to the score generator without communications over the Internet, a WAN, or LAN, or similar network.

In some embodiments, the system may comprise a physical or logical connection established between a remote microprocessor and a mainframe host computer for the express purpose of uploading, downloading, or viewing interactive data and databases on-line in real time. The remote microprocessor may be operated by an entity operating the computer system, including the client server systems or the main server system, and/or may be operated by one or more of the data sources and/or one or more of the computing systems. In some embodiments, terminal emulation software may be used on the microprocessor for participating in the micro-mainframe link.

In an embodiment, the computing system comprises an iPhone®, an iPad®, Android computing system, a smartphone, a tablet computing device, a mobile device, a personal computer, a laptop computer, a cellular phone, a GPS system, a Blackberry® device, a portable computing device, a server, a computer workstation, a local area network of individual computers, an interactive kiosk, a personal digital assistant, an interactive wireless communications device, a handheld computer, an embedded computing device, or the like.

In addition to the systems that have been disclosed herein, the network may communicate with other data sources or other computing devices. The computing system may also comprise one or more internal and/or external data sources. In some embodiments, one or more of the data repositories and the data sources may be implemented using a relational database, such as DB2, Sybase, Oracle, CodeBase and Microsoft® SQL Server as well as other types of databases such as, for example, a signal database, object-oriented database, and/or a record-based database.

Conditional language, such as, among others, “can,” “could,” “might,” or “may,” unless specifically stated otherwise, or otherwise understood within the context as used, is generally intended to convey that certain embodiments include, while other embodiments do not include, certain features, elements and/or steps. Thus, such conditional language is not generally intended to imply that features, elements and/or steps are in any way required for one or more embodiments or that one or more embodiments necessarily include logic for deciding, with or without user input or prompting, whether these features, elements and/or steps are included or are to be performed in any particular embodiment. The headings used herein are for the convenience of the reader only and are not meant to limit the scope of the inventions or claims.

Although this invention has been disclosed in the context of certain preferred embodiments and examples, it will be understood by those skilled in the art that the present invention extends beyond the specifically disclosed embodiments to other alternative embodiments and/or uses of the invention and obvious modifications and equivalents thereof. Additionally, the skilled artisan will recognize that any of the above-described methods can be carried out using any appropriate apparatus. Further, the disclosure herein of any particular feature, aspect, method, property, characteristic, quality, attribute, element, or the like in connection with an embodiment can be used in all other embodiments set forth herein. For all of the embodiments described herein the steps of the methods need not be performed sequentially. Thus, it is intended that the scope of the present invention herein disclosed should not be limited by the particular disclosed embodiments described above.

1-16. (canceled)

17. A computer-implemented method comprising:
receiving login credential information from a first remote computing system in association with a request to access a secure storage account of an account owner over a network;
authenticating, based at least in part on the login credential information, that the request to access the secure storage account is from the account owner of the secure storage account;
subsequent to authentication of the account owner, receiving a first request from the first remote computing system of the account owner to generate a document upload request link, wherein the first request includes information identifying a lifespan of the document upload request link, wherein the lifespan comprises at least one of (a) a number of times the document upload request link is authorized to be used or (b) an expiration time of the document upload request link;
generating a unique hyperlink associated with the secure storage account and the request from the account owner;
receiving a webpage request from a second remote computing system for content associated with the unique hyperlink, wherein the second remote computing system is different than the first remote computing system;
determining that the unique hyperlink is active based at least in part on the lifespan of the document upload request link and a determination that no expiration request associated with the document upload request has been received from the account owner prior to receiving the webpage request from the second remote computing system;
subsequent to determining that the unique hyperlink is active, generating and sending to the second remote computing system a webpage that includes functionality that enables a user of the second remote computing system to upload a document for storage in association with the secure storage account of the account owner, wherein the user of the second remote computing system is not authenticated and is not identified as the account owner, wherein the user of the second remote computing system is prevented from accessing any files stored in association with the secure storage account;
based at least in part on interaction of the user of the second remote computing system with the webpage, electronically receiving an uploaded file from the second remote computing system;
automatically storing the uploaded file in a designated portion of the secure storage account based at least in part on information previously established in association with account settings of the account owner; and
electronically communicating both (a) a first notification to the user of the second remote computing system and (b) a second notification to the account owner, wherein the first notification and the second notification each include at least an indication that the uploaded file has been stored in association with the secure storage account.

18. The computer-implemented method of claim 17, wherein the computer-implemented method is performed by a document management system server.

19. The computer-implemented method of claim 17, wherein the lifespan of the document upload request link is configured such that the unique hyperlink is only active for a single upload.

20. The computer-implemented method of claim 17, wherein the lifespan of the document upload request link is configured such that the unique hyperlink remains active for a set amount of time selected by the account owner unless an expiration request is received from the account owner prior to the set amount of time elapsing.

21. The computer-implemented method of claim 17, further comprising delivering to the account owner an electronic manifest that includes information associated with the uploaded file.

22. The computer-implemented method of claim 21, wherein the information associated with the uploaded file that is included in the electronic manifest comprises at least (a) a name of a sender of the uploaded file and (b) a time that the file was uploaded.

23. The computer-implemented method of claim 17, wherein the designated portion of the secure storage account comprises a specific electronic storage box of the secure storage account of the account owner, wherein the secure storage account of the account owner includes a plurality of electronic storage boxes.

24. The computer-implemented method of claim 23, wherein at least a subset of the plurality of electronic storage boxes are automatically created by a hosting server during account creation to each be associated with preset categories.

25. The computer-implemented method of claim 24, wherein the plurality of electronic storage boxes comprises at least (a) an electronic medical information box comprising at least one medical information file and (b) at least one non-medical electronic storage box, the electronic medical information box having a security access setting that is different than a security access setting of the non-medical electronic storage box.

26. The computer-implemented method of claim 23, further comprising providing a requesting user other than the account owner with access to files stored in one electronic storage box of the plurality of electronic storage boxes while preventing access of the requesting user to electronic storage boxes other than the one electronic storage box.

27. The computer-implemented method of claim 26, wherein the access to the files stored in the one electronic storage box is provided based in part on submission by the requesting user of account information determined from at least one of a barcode, QR code, RFID chip or magnetic strip.

28. The computer-implemented method of claim 27, wherein a physical card provided to the account holder includes the at least one of the barcode, QR code, RFID chip or magnetic strip, wherein the submission by the requesting user occurs at least in part by scanning the physical card.

29. The computer-implemented method of claim 26, wherein the access to the files stored in the one electronic storage box is provided to the requesting user in response to a request received from a mobile application operating on a mobile device belonging to the account holder without requiring submission of login credentials of the account owner.

30. A computer system comprising:
memory; and
a computing device, comprising a physical processor, that is in communication with the memory and that is configured with processor-executable instructions to perform operations comprising:
receiving login credential information from a first remote computing system in association with a request to access a secure storage account of an account owner over a network;
authenticating, based at least in part on the login credential information, that the request to access the secure storage account is from the account owner of the secure storage account;
receiving a first request from the first remote computing system of the account owner to generate a document upload request link, wherein the first request includes information identifying a lifespan of the document upload request link;
generating a unique hyperlink associated with the secure storage account and the request from the account owner;
receiving a webpage request from a second remote computing system for content associated with the unique hyperlink, wherein the second remote computing system is different than the first remote computing system;
determining that the unique hyperlink is active based at least in part on the lifespan of the document upload request link and a determination that no expiration request associated with the document upload request has been received from the account owner prior to receiving the webpage request from the second remote computing system;
based at least in part on determining that the unique hyperlink is active, generating and sending to the second remote computing system a webpage that includes functionality that enables a user of the second remote computing system to upload a document for storage in association with the secure storage account of the account owner, wherein the user of the second remote computing system is not authenticated and is not identified as the account owner, wherein the user of the second remote computing system is prevented from accessing any files stored in association with the secure storage account;
based at least in part on interaction of the user of the second remote computing system with the webpage, electronically receiving an uploaded file from the second remote computing system;
automatically storing the uploaded file in a designated portion of the secure storage account based at least in part on information previously established in association with account settings of the account owner; and
electronically communicating a notification to the account owner that the uploaded file has been stored in association with the secure storage account.

31. The computer system of claim 30, wherein the lifespan comprises a number of times that the document upload request link is authorized to be used.

32. The computer system of claim 30, wherein the lifespan comprises an expiration time of the document upload request link.

33. The computer system of claim 30, wherein the designated portion of the secure storage account comprises a specific electronic storage box of the secure storage account of the account owner, wherein the secure storage account of the account owner includes a plurality of electronic storage boxes.

34. The computer system of claim 30, the operations further comprising:
receiving a request from the first remote computing system of the account owner to securely delete an electronic file stored in the secure storage account of the account owner; and
in response to the request:
deleting at least one version of the electronic file in a primary data store; and
initiating an automated search that attempts to locate one or more versions of the electronic file on the primary data store and the at least one backup data store after deletion of the at least one version of the electronic file in the primary data store.

35. The computer system of claim 34, the operations further comprising:
determining, based on the automated search, that the electronic file (a) is not stored on the primary data store, (b) is not stored on the backup data store, and (c) is not recoverable from any data stored on the primary data store or backup data store; and
electronically communicating to the first remote computing system of the account owner a certification of deletion of the electronic file, wherein the certification of deletion indicates that the primary data store and the at least one backup data store no longer contain the electronic file, and the electronic file has been permanently and securely deleted.

36. The computer system of claim 35, wherein determining that the electronic file is not recoverable comprises attempting to recover the electronic file based at least in part on located metadata associated with the electronic file.
